(19) United States
(12) Patent Application Publication
(10) Pub. No.: US 2021/0406825 A1
(43) Pub. Date: Dec. 30, 2021

(54) ELECTRONIC DEVICE FOR PROVIDING INFORMATION TO COURIER AND CONTROL METHOD THEREOF

(71) Applicant: Coupang Corp., Seoul (KR)

(72) Inventors: Yul Hee Lee, Seoul (KR); Bo Ra Moon, Seoul (KR); Yeon Jung Jo, Seoul (KR); Young Soo Lim, Seoul (KR); Sang Seok Lee, Seoul (KR); Tae Nyun Kim, Seoul (KR); Jeong Ho Pi, Seoul (KR)

(21) Appl. No.: 17/010,684

(22) Filed: Sep. 2, 2020

(30) Foreign Application Priority Data
Jun. 24, 2020 (KR) 10-2020-0077214

(51) Int. Cl. G06Q 10/08; G06Q 30/02

(52) U.S. Cl. CPC G06Q 10/08355; G06Q 30/0282

(57) ABSTRACT

Provided is a method of providing information at a courier terminal, the method including identifying first information on a delivery address, the first information being to be displayed in a first area of a display, identifying second information on a customer, the second information being to be displayed in a second area of the display, identifying third information on at least one image related to delivery, the third information being to be displayed in a third area of the display, and displaying identified information in the first region, the second area, and the third area. The at least one image includes image information associated with completion of a previous delivery corresponding to the address. According to an embodiment of the present disclosure, additional information for an accurate delivery is provided when a courier performs the delivery, thereby reducing a possibility of a misdelivery.

### BACKGROUND

### Technical Field

The present disclosure relates to an electronic device and control method for providing information to a courier delivering an item. One particular embodiment relates to a method of providing information to enable a courier to perform an accurate delivery based on delivery information, and an electronic device using the method.

### Description of the Related Art

As the use of the internet has become common, the e-commerce market is growing. Since transactions of the e-commerce market is made online, a delivery service for transporting purchased items is required. The delivery service refers to a service that a courier delivers an item requested by a customer to a requested delivery destination, and the courier may provide the delivery service based on information acquired through the courier's terminal.

As such a delivery service has been popular, there are many cases where a customer requests an item to be delivered at a specific location in an address of a delivery destination specified by the customer. However, in the case where the customer requests the delivery destination, it is difficult to accurately provide the customer's request, and thus, the courier is not able to comply with the customer's request in many cases. In addition, even if the courier identifies a correct address, an item may be delivered to a wrong delivery location if it is hard to match the address specified by the customer with the delivery destination. As such, if the customer's request is not complied with, or if an item is delivered to a wrong address, the customer's satisfaction may be reduced. Therefore, there is need to address the aforementioned problem.

### SUMMARY

### Technical Goals

An aspect provides a method and an apparatus for effectively provide delivery information to a courier in a delivery process. Another aspect provides a method and an apparatus for effectively transmitting not just information input by a customer, but also information necessary for an accurate delivery among previous delivery history. Yet another aspect provides a method and an apparatus for acquiring and managing information necessary for an accurate delivery based on information provided to a customer, so that the corresponding information is effectively provided to a courier when the corresponding delivery is performed in the future.

### Technical Solutions

According to an aspect, there is provided a method of providing information at a courier terminal, including identifying first information on a delivery address, the first information being to be displayed in a first area of a display, identifying second information on a customer, the second information being to be displayed in a second area of the display, identifying third information on at least one image related to delivery, the third information being to be displayed in a third area of the display, and displaying identified information in the first region, the second area, and the third area. The at least one image may include image information associated with completion of a previous delivery corresponding to the address.

According to another aspect, there is provided a courier terminal, including a transceiver configured to perform communication, a display configured to display information, and a controller configured to identify first information on a delivery address, the first information being to be displayed in a first area of the display, identify second information on a customer, the second information being to be displayed in a second area of the display, identify third information on at least one image related to delivery, the third information being to be displayed in a third area of the display; and display identified information on the first area, the second area, and the third area. The at least one image information may include image information associated with completion of a previous delivery corresponding to the address.

### Effects

According to an embodiment of the present disclosure, additional information for an accurate delivery is provided when a courier performs a delivery, and thus, it is possible to reduce a possibility of a misdelivery. In addition, according to an embodiment of the present disclosure, even without additional information input by a customer, information for performing an accurate delivery may be managed using previous delivery history and such information may be provided to the courier in a timely manner, and thus, it is possible to perform a delivery effectively.

### BRIEF DESCRIPTION OF THE DRAWINGS

FIG. 1 is a diagram illustrating a delivery system according to an embodiment of the present disclosure.

FIG. 2 is a flowchart illustrating a method for providing information related to delivery at a courier terminal according to an embodiment of the present disclosure.

FIG. 3 is a flowchart illustrating a method for providing information related to delivery at a courier terminal according to an input corresponding to a delivery progress according to an embodiment of the present disclosure.

FIG. 4 is a flowchart illustrating a method of acquiring image information provided for information related to delivery and providing the acquired image information, according to an embodiment of the present disclosure.

FIG. 5 is a diagram illustrating information exchanged between nodes in a delivery process and corresponding operations of the respective nodes, according to an embodiment of the present disclosure.

FIG. 6 is a diagram illustrating a user interface (UI) associated with a delivery map, which is provided at a courier terminal, according to an embodiment of the present disclosure.

FIG. 7 is a diagram illustrating a UI associated with a delivery list, which is provided at a courier terminal, according to an embodiment of the present disclosure.

FIG. 8 is a diagram illustrating a UI associated with a customer, which is provided at a courier terminal, according to an embodiment of the present disclosure.

FIG. 9 is a diagram illustrating a UI provided at a courier terminal, where an image regarding a previous delivery is provided and an image regarding a current delivery is allowed to be input, according to an embodiment of the present disclosure.

FIG. 10 is a diagram illustrating a courier terminal according to an embodiment of the present disclosure.

### DETAILED DESCRIPTION

Exemplary embodiments of the present invention are described in detail with reference to the accompanying drawings.

Detailed descriptions of technical specifications well-known in the art and unrelated directly to the present invention may be omitted to avoid obscuring the subject matter of the present invention. This aims to omit unnecessary description so as to make clear the subject matter of the present invention.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

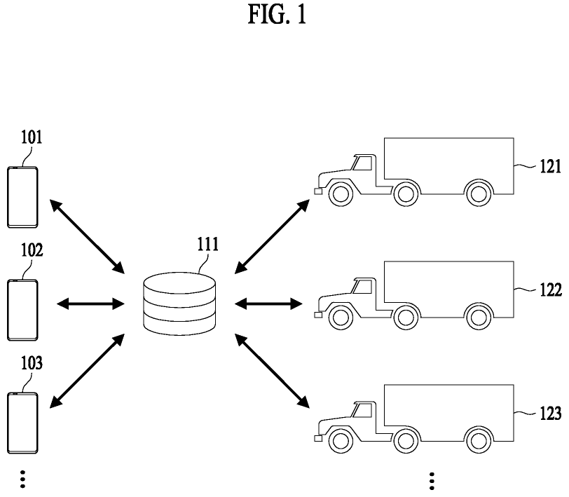

FIG. 1 is a diagram illustrating a delivery system according to an embodiment of the present disclosure.

Referring to FIG. 1, a delivery system including customers 101, 102, and 103, a server 111, and couriers 121, 122, and 123 according to an embodiment of the present disclosure is are illustrated. In the embodiment, the customers 101, 102, and 103 and the couriers 121, 122, and 123 may communicate with the server 111 through customer terminals and courier terminals and identify information provided.

The customers 101, 102, and 103 each may place a delivery request through the server 111 and receive information related to delivery. The server 111 may manage the information related to delivery and may also manage information on an item, a delivery of which is requested from a customer. More specifically, the customers 101, 102, and 103 each may purchase a desired item through the server 111, and may place a delivery request through information exchange with the server 111. In the embodiment, the server 111 may include a plurality of servers capable of performing communication or may include at least some of the plurality of servers.

The server 111 may transmit information associated with an item delivery for the customers to the couriers 121, 122, and 123. In the embodiment, the server 111 may provide the couriers 121, 122, and 123 with delivery-related item information and information related to delivery for performing a delivery. In the embodiment, the information related to delivery may include information on an address to which an item is to be delivered, information on a location specified by a customer to place the item, other delivery-related setting information requested by the customer, and at least one input information additionally that should be input to deliver the item.

The couriers 121, 122, and 123 may perform a delivery based on the aforementioned information and may provide information associated with a delivery progress to the server 111. More specifically, the server 111 may provide information associated with the delivery to be performed by the couriers 121, 122, and 123, and the couriers 121, 122, and 123 may be provided with information on a customer corresponding to a building to which the delivery is to be performed, address information, and specific delivery-related setting information. The couriers 121, 122, and 123 may perform the delivery based on the received information and provide the information associated with the delivery progress to the server 111. More specifically, when the delivery is completed, image information associated with delivery completion and information indicating the delivery completion may be transmitted to the server 111, and upon receiving such information, the server 111 may provide a customer corresponding to a corresponding item with the image information associated with the delivery completion. Through the provision of such information, the customer may identify whether the item has been properly delivered, and provide feedback to the server 121. In the embodiment, the feedback may include at least one of: information as to whether a delivery address is correct, information as to whether the delivery is completed in compliance with a set delivery option, and information as to a state of a delivered item. In addition, the customer may provide a feedback related to the delivery in response to a request from the server 111 or triggering by the customer, and the server 111 may record the feedback and provide information including the feedback from the customer to the couriers 121, 122, and 123, thereby improving satisfaction of the delivery.

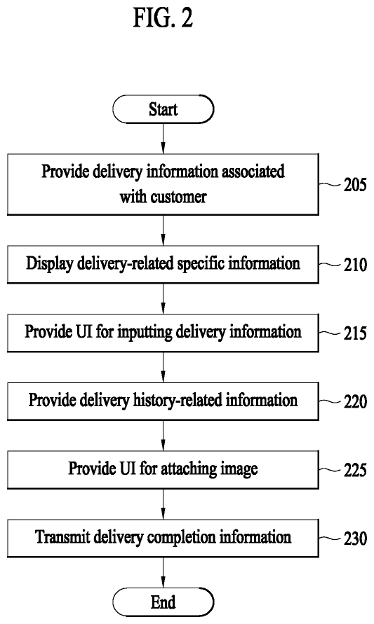

FIG. 2 is a flowchart illustrating a method for providing information related to delivery at a courier terminal according to an embodiment of the present disclosure.

Referring to FIG. 2, a method for providing information related to delivery at a courier terminal is illustrated.

In operation 205, delivery information for a customer may be displayed on a terminal of a courier. The delivery information may include information on an item to be delivered, delivery address information, and delivery option information specified by the customer. In addition, in the embodiment, the delivery information may include delivery attention information. More specifically, information generated according to previous feedback from the customer may be provided to the courier. For example, for a customer from whom feedback related to the misdeliveries have been frequently received, information indicating a misdelivery alert may be provided when the delivery is being made. In addition, in the case where the customer sets a delivery location, if a lot of negative feedback has been received regarding the delivery location in a previous delivery, an attention message may be provided to identify the delivery location.

In operation 210, delivery-related detailed information may be displayed at the terminal of the courier. In the embodiment, the delivery-related detailed information may include at least one of customer information, customer address information, delivery tip information, information requested from the customer, and customer instructions. The customer address information may include an address in a first format and an address in a second format. An address in each format may be input by a customer's input or by searching an address database based on the customer's input, and since the addresses in the different formats are provided, the courier may perform a delivery more easily. In the embodiment, the address in the first format may be address information provided by the customer's input, and the address in the second format may be an address provided for convenience of the courier, but not limited thereto. In the embodiment, the information requested from the customer may be information requested by the customer when ordering the delivery, and such information requested from the customer may include information input by selecting a preset check box and information input in the form of a text or message directly by a user. Based on the information requested from the customer, the courier may provide a delivery service more adaptive to the customer.

In operation 220, a UI for inputting delivery information may be provided at the courier terminal. In the embodiment, the courier may input, to the terminal, information on a current delivery and an associated UI may be provided at the terminal. In the embodiment, the UI may display at least one of delivery-related request information filled in by the customer and information for accessing a delivery destination, and delivery-related location information specifically specified by the customer may be provided. Also, in the embodiment, even on the UI for inputting information, information generated according to previous feedback from the customer may be provided to the courier.

In operation 225, the courier terminal may provide a UI for attaching an image associated with completion of the current delivery. In addition, at least one of information displayed in the previous operation may be displayed, and the UI for attaching an image indicating current delivery completion information may be provided together with a UI for inputting a location where the courier has actually performed the delivery. In addition, the courier terminal may display image information indicating that the delivery is performed without any problem in the previous operation. According to an example, at least one of the server and the courier terminal may store, in the previous operation, photos of the delivery location corresponding to the current delivery, and a photo regarding without negative feedback or with positive feedback from the customer may be selected from the stored photos and displayed together. As such, with provision of a previous delivery image for the delivery location, the delivery may be performed in a way corresponding to a request from the customer. More specifically, the courier may input delivery status information including at least one of Refusal to receive, Failed delivery, and Delivery complete. Refusal to receive refers to the case where the customer has refused to receive an item, and accordingly, a delivery process of the item may be terminated and then a refund process may be performed. Failed delivery refers to the case where a delivery is not completed, that is, where the delivery cannot be performed or is to be performed in a next time, and accordingly, information on a corresponding item may be changed in the server so that a refund process or a redelivery of the item is performed. When information regarding Delivery Complete is input, delivery of an item may be completed and associated information may be provided to the customer. In the embodiment, the courier may input image information regarding a current delivery in order to complete the delivery. In an example, an item may be placed at a location in compliance with the customer's request, and associated image information may be acquired and transmitted to the server through the courier terminal. As a delivery process is performed as described above, it is possible to control a delivery status of an item depending on a situation, and when the delivery is completed, it is possible to effectively provide associated information.

In operation 230, as the courier confirms information on the completion of the delivery, the information on the completion of the delivery may be transmitted to the server. In addition, an image associated with the completion of the current delivery, which is acquired in the previous operation, may also be transmitted to the server. As such, as the server acquires the image regarding the completion of the current delivery together with information indicating the completion of the delivery, it is possible to transmit associated information together when transmitting information to the customer. Meanwhile, in the embodiment, the courier terminal may transmit image information directly to a customer terminal over a commercial communication network.

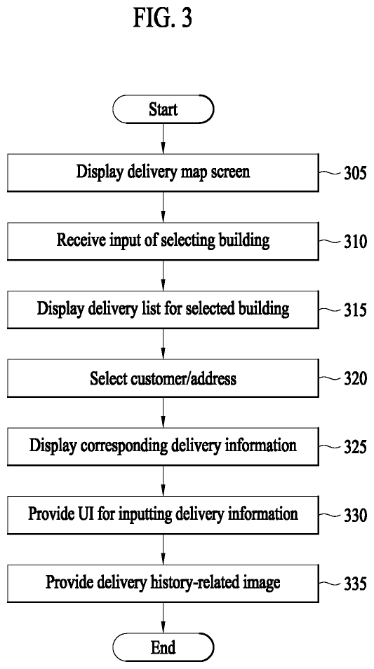

FIG. 3 is a flowchart illustrating a method for providing information related to delivery at a courier terminal in response to an input corresponding to a delivery progress according to an embodiment of the present disclosure.

Referring to FIG. 3, a method of providing information related to delivery at a courier terminal in response to an input received in a delivery progress is illustrated.

In operation 305, the courier terminal may display delivery-related map information. In the embodiment, as the map information may be displayed as a map of an area around a current location of a courier, and an icon corresponding to a building to which an item to be delivered is located may be displayed on the map. Either a number of items corresponding to the building or a number of customers corresponding to the building may be displayed within the icon, and based on such information, the courier may easily identify a delivery schedule based on the map information and may identify, based on the icon, delivery information regarding a customer corresponding to the building or delivery information regarding an item to be delivered. When attention are needed in accordance with the customer's feedback, associated information may be further provided in the delivery information. More specifically, a message indicative of a misdelivery alert or a message for identifying a delivery location specified by the customer may be displayed. In addition, delivery-related specific option information specified by the customer may also be provided.

In operation 310, the courier terminal may receive an input of selecting a building. In the embodiment, the input of selecting the building may include a touch input received at a location corresponding to the building, and may include a touch input received at a location corresponding to an icon displayed on the map.

In operation 315, specific information on a customer who wishes an item be delivered to the building or specific information on the item to be delivered may be displayed in response to the input of selecting the building. The specific information may include information for identifying the customer, and based on such information, the courier may compare waybills affixed onto items to identify which item is to be delivered to the customer among the plurality of items. In addition, the specific information may include information that is provided when attention is needed in accordance with the customer's feedback, and the specific information may include at least one of: delivery address information in at least one format and deliver-related specific option information. Such specific information may be provided in the form of a list including at least one customer or at least one item, and such a list may show at least one of a customer or item regarding which a delivery is to be performed in the building.

In operation 320, the courier terminal may receive an input for selecting a customer or an address. More specifically, an input of selecting a customer or an item from a list of customer or item information may be received, and accordingly, specific information on the selected customer or item may be displayed.

In operation 325, delivery information corresponding the selected customer or item may be displayed. In the embodiment, the courier may identify, based on the displayed delivery information, information on a customer to which the delivery is to be performed or information on an item to be delivered. The delivery information may include information requested by the customer and information for accessing a corresponding delivery destination and may include information that is displayed when attention is needed in accordance with the customer's feedback. In addition, at least one icon for inputting information related to delivery may be displayed. More specifically, an icon for inputting at least one of Refusal to Receive, Failed delivery, and Delivery complete may be displayed. A UI corresponding to the icon may be provided. In the embodiment of the present disclosure, a process to be performed when Delivery complete is implemented will be described.

In operation 330, in response to an input for Delivery complete, the courier terminal may provide a UI for inputting delivery information regarding completion of the current delivery. More specifically, the courier may input, through the UI, information indicating that the current delivery is completed. In addition, the courier may input image information associated with the current delivery together with the aforementioned information.

In operation 335, the courier terminal may provide information associated with delivery history. In the embodiment, the information associated with the delivery history may be provided on the UI associated with inputting of the delivery information or may be provided on a separate screen. An image associated with the delivery history may include an image without negative feedback from the customer among previously acquired images corresponding to a corresponding delivery destination and a corresponding delivery option. More specifically, an image without negative feedback from the customer among previous delivery completion images corresponding to the current delivery address, customer, and delivery option may be provided to the courier terminal. In addition, in the embodiment, the image may include at least one image, and an image with positive feedback from the customer may be preferentially displayed, if any. As the image without negative feedback from the customer is provided on the UI associated with inputting of delivery information, the courier may compare the image with provided image information to identify whether the corresponding delivery has been correctly received, and accordingly, it may be possible to perform the delivery in compliance with the customer's request.

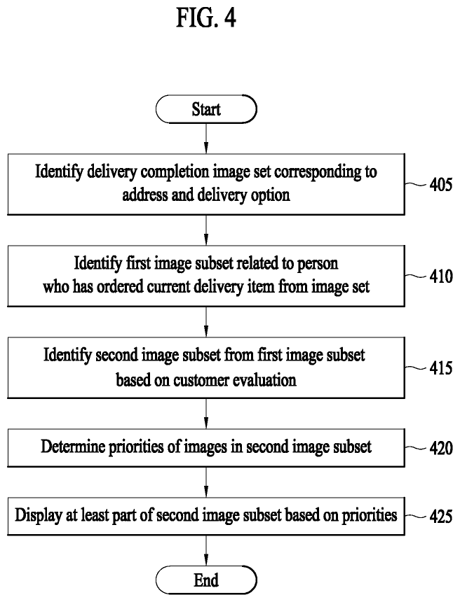

FIG. 4 is a flowchart illustrating a method of acquiring image information provided for information related to delivery and providing the acquired image information, according to an embodiment of the present disclosure.

Referring to FIG. 4, a method of acquiring image information in association with information related to delivery and providing the acquired image information to a courier terminal is illustrated. In the embodiment, the image information may be an image acquired in a server and may be image information previously reported by a corresponding courier terminal or another courier terminal. The embodiment is described that the image information is identified by the server and an identified image is provided to the courier terminal, but the present disclosure is not limited thereto, and the courier terminal may be implemented in a manner that selects an associated image from among images stored in the courier terminal and shows the selected image.

In operation 405, the server may identify a delivery address and a delivery option of a delivery currently performed by a courier, and may identify a delivery completion image set corresponding to the identified information. More specifically, the server may identify an image set by searching, based on previous delivery history information, a delivery completion-related image which corresponds to the delivery address and the delivery option, and which has no negative feedback among delivery completion-related images provided to the customer. Such an image set includes images with no negative feedback having received from the customer when the images were transmitted to the customer with the same address and the same delivery option, and if the courier performs a delivery with reference to the images, negative feedback is less likely to be received as before.

In operation 410, the server may identify a first image subset associated with a person ordering a current delivery item from the image set acquired in the previous operation. For the image set, images are selected based on an address and a delivery option, and additionally, images collected in association with order completion among orders placed by the same person at the corresponding address may be identified as the first image subset. More specifically, a delivery completion-related image associated with the same delivery address, customer, and delivery option as those of the current delivery item may be identified.

In operation 415, a second image subset may be identified based on a customer evaluation for the corresponding delivery completion-related image in the first image subsets. In the embodiment, the customer evaluation may include customer feedback information for the corresponding delivery, and may be passively identified, for example, by selecting an image without negative feedback and may be actively identified, for example, by selecting an image with positive feedback from a customer. As such, the server may select an image without negative feedback and an image with positive feedback among images associated with the corresponding user. In addition, an image with negative feedback received may be selected to inform the courier of an incorrect delivery, and, in this case, the image with negative feedback may be displayed in contrast to an image without negative feedback, so that the courier can perform deliver while referring to the both images.

In step 420, the server may identify priorities of images in the second image set. If a number of the images in the second image subset is not sufficient, the priorities may be identified from the first image subset, and if a number of the images in the first image subset is not sufficient, the priorities may be identified from the image set. More specifically, the priorities of the images may be identified such that an image with positive feedback has a higher priority than that of an image without negative feedback. In addition, an image recently acquired may have a higher priority than that of an image acquired a long time ago. In this manner, the priorities may be assigned to the corresponding images.

In operation 425, the server may transmit, to the courier terminal, at least part of information on the images to which the priorities is assigned, so that corresponding images are displayed at the courier terminal. At the courier terminal, the images may be displayed based on the priorities, and an image having a higher priority may be displayed preferentially. For example, two images with a highest priority may be displayed at the courier terminal, and an image having a next highest priority may be identified by scrolling or through a separate UI.

Meanwhile, in the embodiment, for convenience of explanation, it has been described that each image set and each image subset are searched sequentially, but the respective operations may be performed by one search, and some of the operations may be omitted or may be performed in combination with other separate operations. In addition, if a number of images acquired in a subsequent operation is not sufficient, images acquired in a previous operation may be selected and provided to the courier terminal. In this case, the operation of determining priorities of images may be performed on the basis of an image subset acquired in the corresponding previous operation, not on the basis of the second image subset.

In addition, in an exemplary embodiment, if delivery addresses are the same, the delivery addresses may be basically determined as the same delivery destination, and an image associated with a delivery option corresponding to a current delivery based on the corresponding delivery address may be provided to a customer. However, since there are some cases where a customer requests a different delivery place even when selecting the same delivery option, it is possible to handle even the case where a different customer with the same address orders an item. Also, in the embodiment, an operation of selecting a certain subset may be omitted.

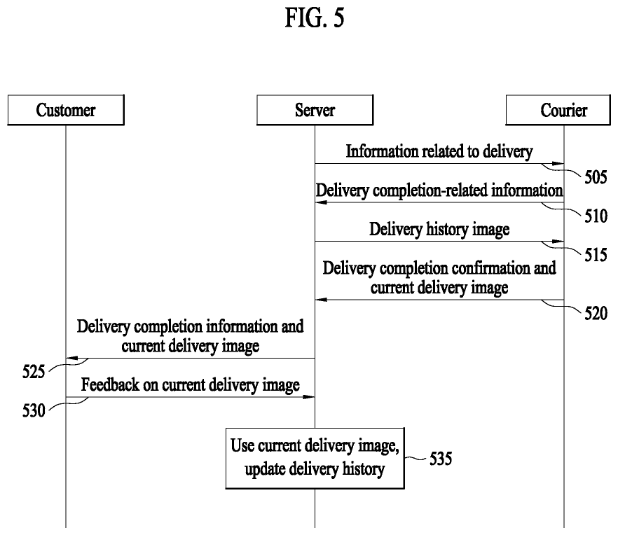

FIG. 5 is a diagram illustrating information exchanged between nodes in a delivery process and corresponding operations of the respective nodes, according to an embodiment of the present disclosure.

Referring to FIG. 5, a method of exchanging information between a customer, a server, and a courier according to an embodiment of the present disclosure is illustrated.

In operation 505, the server may transmit information related to delivery to the courier. The information related to delivery may be transmitted based on at least one of triggering by the server and triggering by the courier. The information related to delivery may include at least one of waybill information, delivery address information, and delivery option information of an item to be delivered, and at least one of the information related to delivery described in the specification may be further transmitted. The courier may perform a delivery based on the received information related to delivery.

In operation 510, the courier may perform the delivery and may request for a UI for inputting regarding completion of the delivery. In the embodiment, before applying a delivery completion input, the courier may acquire image information associated with the current delivery and transmit the acquired image information to a server, and, at this point, a corresponding image may be displayed based on previous delivery history. By requesting the UI, it is possible to input final delivery completion information and acquire the associated image information from the server.

In operation 515, the server may acquire a previous delivery completion-related image associated with the current delivery from the delivery history based on the received information and may transmit the same to the courier. In the embodiment, the delivery completion-related image may be selected based on at least one of an address for the current delivery, a delivery option, customer information, and customer feedback information, and priority information of the corresponding image may be transmitted while the image information is transmitted. The priority information may be determined based on a customer's feedback corresponding to the delivery completion-related image, and a date when the image was photographed and customer information associated with the corresponding image may be further determined. In addition, a priority of an image with positive feedback may be increased, and a priority of an image without negative feedback may be set to be lower than the priority of the image with the positive feedback.

In operation 520, the courier may identify delivery completion based on the received information. More specifically, the courier may identify whether the delivery has been properly performed, based on the acquired delivery completion-related image which is provided from the server. In addition, the courier may transmit an image associated with completion of the current delivery to the server. For example, if a current delivery option is Leave at Door, the courier may place an item at the door, take a photo, and transmit the photo to the server.

In operation 525, the server may identify, based on the received information, whether the delivery of the item is completed and may provide associated information to the customer. In the embodiment, the information transmitted to the customer may include at least part of the information received in operation 520. As such, with the delivery completion image transmitted to the customer, the customer may identify the delivery completion image through a customer terminal even without a delivery address and may immediately provide feedback based on the image.

In operation 530, the customer may transmit feedback information for a current delivery image based on the received information. For example, when a delivery address identified based on the image is not an address specified by the customer, the customer may transmit feedback related to the misdelivery to the server. In addition, when the delivery corresponds to an address and an option which are specified by the customer, the customer may transmit positive feedback. In addition, when information acquired from a delivery image corresponds to the address specified by the customer but does not correspond to the delivery option specified by the customer, the customer may transmit feedback associated with the delivery option to the server.

In operation 535, the server may update the delivery history based on the received information, and when the delivery is performed in the future to the same address based on the acquired image and the feedback information, the server may provide the courier terminal with the delivery completion-related image.

As described above, auxiliary information for an accurate delivery may be provided through information exchange between the customer, the server, and the courier, and after performing the delivery, the courier may provide delivery completion-related information to the customer and acquire feedback information regarding a misdelivery and a delivery option. In the embodiment, if negative feedback is received for the corresponding delivery, associated information may be collected, and, at a next delivery to the same address or customer, alert information generated based on the previous negative feedback may be provided to the courier so that the courier performs the delivery based on the provided information, thereby increasing user satisfaction.

Meanwhile, in the embodiment, a previous delivery completion-related image may be provided before inputting a delivery completion-related image. In this case, when delivery-related detailed information is provided to the courier, the corresponding image may be displayed on the courier terminal, and, in this case, the courier may identify corresponding image information before placing a delivery item and may perform the delivery in a way corresponding to a result of the identification. Meanwhile, the delivery completion-related image provided in this case may be displayed together with a delivery-related alert message.

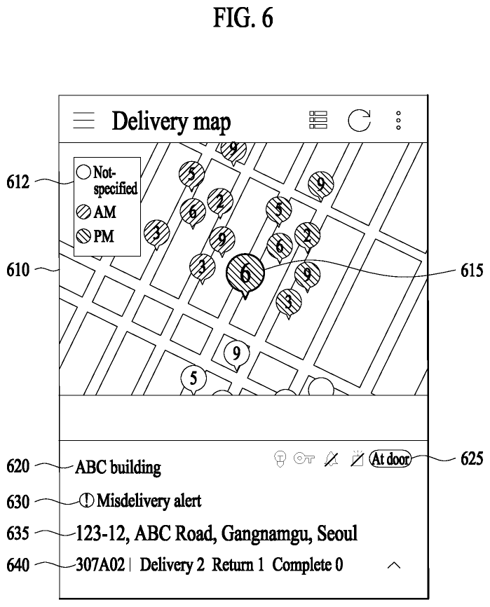

FIG. 6 is a diagram illustrating a UI associated with a delivery map, which is provided at a courier terminal, according to an embodiment of the present disclosure.

Referring to FIG. 6, a UI associated with the delivery map displayed at the courier terminal is illustrated. An embodiment will be described based on a display of the courier terminal, and the display may be a touch screen through which information is to be displayed and input.

A map image may be displayed in a first area 610. Also, delivery-related schedule information 612 may be displayed in at least a portion of the first area 610. The corresponding delivery-related schedule provides reference information to perform the delivery based on time information, so that the delivery is performed at a predetermined time depending on a location of a building. Also, an information icon 615 may be displayed on the map. The information icon 615 may be displayed to correspond to the building, and a number of deliveries to be performed to the building may be displayed within the icon 615.

In the embodiment, in response to an input of selecting the icon 615, delivery information corresponding to the icon 615 may be displayed under the first area 610. In the embodiment, the delivery information includes information on a list of deliveries to be performed to the building corresponding to the corresponding icon 615, and, in the embodiment, information on one delivery may be displayed first.

The delivery information may include a building name 620. In addition, delivery option-related information 625 may be displayed. The delivery option-related information 625 includes information as to whether there is a delivery tip, whether additional information is necessary for entrance, whether bell ringing is allowed, whether knocking is allowed, and a specific location of the delivery. In the embodiment, information on the specific location of the delivery specifies that an item to be delivered should be placed at a door.

In addition, in the embodiment, the delivery information may include an alert message regarding the delivery. In the embodiment, the alert message may be displayed saying “Misdelivery alert”, and the message may be generated and displayed based on the customer's previous delivery feedback. In addition, an attention message regarding a delivery option may be also provided. For example, a message to ensure a delivery location specified by the customer, such as “Leave at door” and “Leave at security office” may be selectively output.

The delivery information may include address information 635 of the building, which is generated based on information input by the customer.

The delivery information may include waybill information 640 and additional task information. The additional task information may include a number of items to be delivered, a number of items to be returned, and a number of items that have been delivered. Based on this information, the courier may adjust a delivery schedule.

In the embodiment, if one address is selected from a displayed list, an associated UI is further provided at the courier terminal, which will be described below.

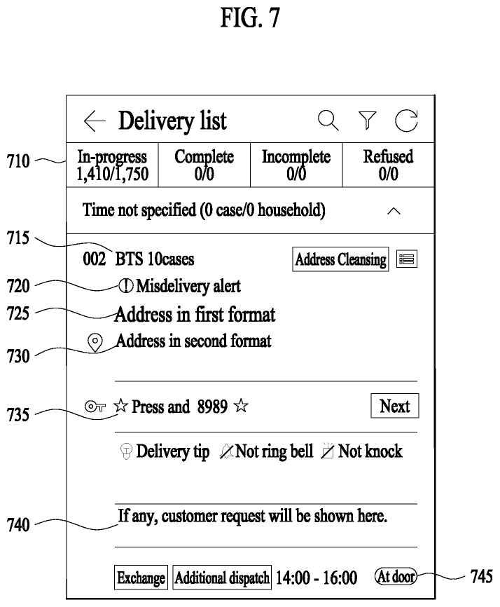

FIG. 7 is a diagram illustrating a UI associated with a delivery list, which is provided at a courier terminal, according to an embodiment of the present disclosure.

Referring to FIG. 7, a UI associated with a delivery list displayed at a courier terminal is illustrated. An embodiment will be described based on a display of the courier terminal, and the display may be a touch screen through which information is to be displayed and input.

Delivery list-related information may be displayed on a display of the terminal. In the embodiment, information 710 regarding all deliveries currently in progress may be shown on the display. In the information 710 regarding all the deliveries currently in progress, information on a number of items to be delivered and a number of items that have been delivered may be shown.

At reference numeral 715, a name of a customer who will receive a current delivery and information on a number of items to be delivered to the customer may be shown. In the embodiment, the number of items corresponding to the customer may be integrally managed based on waybill information of separate items.

At reference numeral 720, an alert message regarding the current delivery may be shown. In the embodiment, the alert message may be displayed saying “Misdelivery alert”, and the message may be generated and displayed based on the customer's previous delivery feedback. In addition, an attention message regarding a delivery option may be also shown. For example, a message to ensure a delivery location specified by the customer, such as “Leave at door” and “Leave at security office” may be selectively output.

At reference numerals 725 and 730, a delivery address corresponding to the customer may be shown. In the embodiment, the delivery address may be shown in at least one format, and an address in a first format may be shown at reference numeral 725 while an address in a second format may be shown at reference numeral 730. In the embodiment, an address format specifying the delivery destination may be variously set, and addresses in multiple formats may be shown for convenience of a courier. For example, at least one of an address determined by a user's input, an address specified by an administrative agency, and a previously set address of a delivery destination may be determined as an address format, and the address in such a format may be shown at reference numerals 725 and 730.

At reference numeral 735, delivery-related specific information may be shown. For example, information including at least one of password information for accessing a delivery location, a delivery tip information icon, whether bell ringing is not allowed, and whether knocking is not allowed may be shown, and the courier may effectively reach the delivery location based on such information.

At reference numeral 740, an additional request input by the customer may be shown, and the customer may fill in corresponding information when purchasing an item or when requesting the delivery of the item, and accordingly, the courier may effectively deal with the customer's request.

At reference numeral 745, delivery location information specified by the customer may be provided. In the embodiment, information viewed at a delivery location specified by the customer may include information determined by the customer by selecting an input box, and, in the embodiment, it is illustrated that the customer has requested the delivery to leave at a door of the customer's address.

Based on the delivery list information provided as above, the courier may effectively perform the delivery, and, through an input to at least a portion of the present UI, a UI associated with the customer may be displayed.

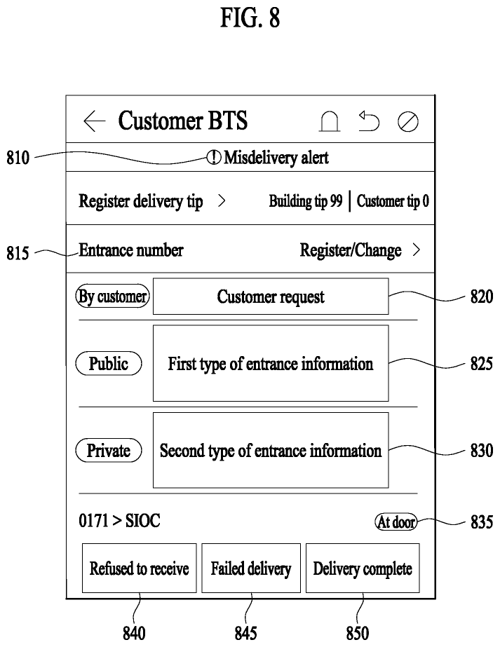

FIG. 8 is a diagram illustrating a UI associated with a customer, which is provided at a courier terminal, according to an embodiment of the present disclosure.

Referring to FIG. 8, a UI associated with a customer displayed at a courier terminal is illustrated. An embodiment will be described based on a display of the courier terminal, and the display may be a touch screen through which information is to be displayed and input.

At reference numeral 810, an alert message regarding a current delivery may be provided. In the embodiment, the alert message may be displayed saying “Misdelivery alert”, and the message may be generated and displayed based on the customer's previous delivery feedback. In addition, an attention message regarding a delivery option may be also provided. For example, a message to ensure a delivery location specified by the customer, such as “Leave at door” and “Leave at security office” may be selectively output.

At reference numeral 815, a UI for displaying or registering information for entrance into a delivery destination is shown. Such information for entrance into the delivery destination may be registered by a customer or a courier, and may include entrance password information.

At reference numeral 820, a customer request input by the customer may be shown. Although specific information is not shown in the present embodiment, information for specifying a more specific delivery location, information for requesting a phone call after the delivery, and the like may be filled in by the customer and transmitted to a courier terminal through the server.

At reference numerals 825 and 830, information for entrance may be shown. In the embodiment, first type of entrance information may be shown at reference numeral 825, and second type of entrance information may be shown at reference numeral 830. The first type of entrance information may include public password information for entrance into a corresponding building, and the second type of entrance information may include password information for entrance into the corresponding delivery destination.

Delivery location information specified by the customer may be provided at reference numeral 835. In the embodiment, information shown at the delivery location specified by the customer may include information determined by the customer by selecting an input box, and in the present embodiment, it is illustrated that the customer has requested the delivery to leave at a door of the customer's address.

In the embodiment, a UI through which a courier inputs information regarding performing a delivery is illustrated. More specifically, an icon 840 of Refuse to Receive, an icon 845 of Failed delivery, and an icon 850 of Delivery Complete are illustrated. Refused refers to the case where a customer has refused to receive an item, and accordingly, a delivery process of the item may be terminated and then a refund process may be performed. Failed delivery refers to the case where the delivery is not completed, that is, where the delivery cannot be performed or is to be performed in a next time, and accordingly, information on a corresponding item may be changed in the server so that a refund process or a redelivery of the corresponding item is performed. When information regarding Delivery complete is input, the delivery of an item may be completed and associated information may be provided to the customer. In the embodiment, in order to complete the delivery, the courier may input image information regarding the current delivery, and an image may be acquired through a current screen or a separate UI for inputting a photo. In the embodiment, a UI will be described on the basis of Delivery complete.

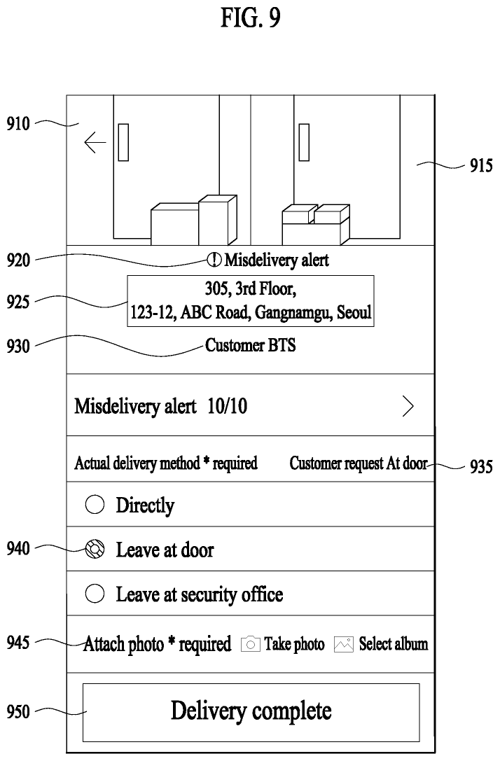

FIG. 9 is a diagram illustrating a UI provided at a courier terminal, where an image regarding a previous delivery is provided and an image regarding a current delivery is allowed to be input, according to an embodiment of the present disclosure.

Referring to FIG. 9, a UI associated with a customer displayed at a courier terminal is illustrated. An embodiment will be described based on a display of the courier terminal, and the display may be a touch screen through which information is to be displayed and input. In addition, the UI in the embodiment may be displayed to input final information related to delivery after selecting Delivery complete, and may include a UI for selecting a delivering method and uploading an image regarding the current delivery.

At reference numerals 910 and 915, image information referenceable for the delivery based on the delivery history are illustrated. As described in the previous embodiment, it is possible to select and display photos which correspond to current delivery information in previous delivery history, and which does not have negative feedback and have positive feedback from a customer. In addition, an image displayed in a corresponding area may be additionally identified by scrolling, and an image to be displayed first may be an image with a high priority.

At reference numeral 920, an alert message regarding the current delivery may be shown. In the embodiment, the alert message may be displayed saying “Misdelivery alert”, and the message may be generated and displayed based on the customer's previous delivery feedback. In addition, an attention message regarding a delivery option may be also shown. For example, a message to ensure a delivery location specified by the customer, such as “Leave at door” and “Leave at security office” may be selectively output.

At reference numeral 925, a delivery address may be shown to be identified by a courier. With the delivery address shown as described above, it is possible to finally identify whether the delivery address is correct.

At reference numeral 930, customer information regarding the delivery may be shown. In addition, information regarding a current alert message may be provided close to the customer information, and if an input to a corresponding area is received, information regarding a previous misdelivery may be provided. Such information may be provided to the courier terminal by selecting, at the server, an image with feedback regarding a previous misdelivery received.

At reference numeral 935, specific delivery place information specified by the customer is shown, and the courier may identify the same and provide, at reference numeral 940, information through a UI for inputting a place where the delivery of is performed. In the embodiment, the customer may request the delivery to be left at a door, and the courier may input, through an input to a corresponding area, information indicating that the delivery is left at door. According to the input, an icon in front of Leave at door may be displayed as being selected. Meanwhile, the information shown at reference numeral 940 may include information indicating a delivery complete type.

At reference numeral 945, a UI for attaching an image regarding the current delivery is provided. The courier may perform the delivery, capture an image regarding the delivery, and upload the image through the UI. In the embodiment, the uploaded image may be shown on the same screen together with the images shown at reference numerals 910 and 915.

An icon regarding delivery completion is provided at reference numeral 950, and if an input to the icon is received, information regarding the delivery completion may be finally transmitted to the server. In the embodiment, information may be transmitted to the server in real time in response to a user's input, and a UI may be implemented in a manner in which a final input is confirmed in response to the input to the corresponding icon.

As such, when inputting delivery completion-related information, a delivery image corresponding to current delivery information and having no negative feedback from the customer may be shown together, and therefore, the courier may be able to more certainly identify the customer's request and accordingly more accurately and effectively perform the delivery.

In the above embodiments, the UIs of FIGS. 6 to 9 may be sequentially provided. More specifically, the UI of FIG. 7 may be displayed in accordance with an input to the UI of FIG. 6, and then the UIs of FIGS. 8 and 9 may be sequentially displayed in accordance with corresponding inputs. In addition, in the overall embodiments, displaying a UI may be described in phases to display information for respective areas.

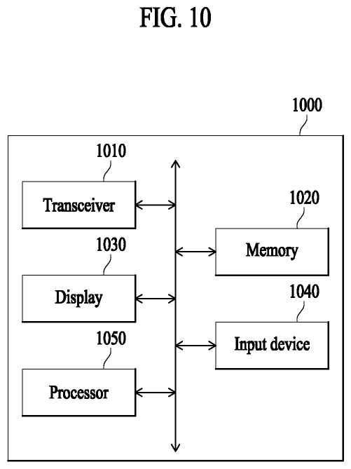

FIG. 10 is a diagram illustrating a courier terminal according to an embodiment of the present disclosure.

Referring to FIG. 10, a functional block illustrating the courier terminal according to an embodiment is illustrated, and the courier terminal may include a transceiver 1010, a memory 1020, a display 1030, an input device 1040, and a processor 1050.

The transceiver 1010 may communicate with another node. The transceiver 1010 may perform wired and wireless communication, and may use various common wireless communication platforms for the wireless communication.

The memory 1020 may store information on an operation of the courier terminal, and may store at least part of information transmitted and received through the transceiver 1010.

The display 1030 may display information on the operation of the courier terminal.

The input device 1040 may receive an input regarding the courier terminal. For example, the display 1030 and the input device 1040 may be implemented through a touch screen.

The processor 1050 may perform overall control in association with an operation of the courier terminal. The processor 1050 may include at least one sub-processor.

In addition, in the embodiment, the customer terminal may also include a configuration corresponding to the courier terminal, and the server may also include a transceiver for communicating with another node and a processor for controlling the server in association with an operation of the server and performing a control in association with an operation the server. Also, in the embodiment, the operation of the processor may be referred to as an operation of the controller.

Meanwhile, the present disclosure and drawings have been described with respect to preferred embodiments of the present disclosure, although specific terms have been used, they are merely used in a general sense to easily explain the technical contents of the present disclosure and to help understand the present disclosure. It is not intended to limit the scope of the present disclosure. It is apparent to those skilled in the art to which the present disclosure pertains that other modified examples based on the technical idea of the present disclosure can be implemented in addition to the embodiments disclosed herein.

1. A method of providing information at a courier terminal, the courier terminal comprising a display and a processor configured to cause information to be displayed on the display, the method comprising:
identifying first information on a delivery address;
identifying second information on a customer;
receiving a plurality of images selected from a set of images stored at a server previously acquired during completion of one or more previous deliveries corresponding to the delivery address, the plurality of images being automatically selected by the server based on customer feedback information regarding the one or more previous deliveries;
identifying third information regarding the plurality of images related to a delivery;
displaying the first information in a first area of a display, the second information in a second area of the display, and the third information in a third area of the display, wherein a first image of the plurality of images related to the delivery is displayed within the third area of the display without scrolling images on the display, the first image having a higher priority than a second image of the plurality of images based on the customer feedback information; and
displaying the second image from the plurality of images in the third area of the display subsequent to the displaying of the first image, in response to scrolling the images on the display.

2. The method of claim 1, further comprising:
identifying fourth information on a delivery complete type; and
displaying the fourth information in a fourth area of the display.

3. The method of claim 2, further comprising:
receiving an input of selecting one of the fourth information displayed in the fourth area; and
changing a shape of an icon corresponding to the information selected in response to the input.

4. The method of claim 1,
wherein the third information comprises the priority information regarding at least a portion of the plurality of images,
wherein the plurality of images are displayed on the display based on the priority information.

5. The method of claim 4, wherein the priority information is determined based on at least one of the following:
an acquisition time of the plurality of images; and
the customer-related information corresponding to the plurality of images.

6. The method of claim 4, wherein the priority information is determined based on information on a delivery location corresponding to the plurality of images and the customer feedback information corresponding to the plurality of images.

7. The method of claim 1, further comprising:
identifying fifth information for attaching a photo;
displaying the fifth information in a fifth area of the display;
in response to an input to the fifth area, acquiring an image stored in the terminal or an image photographed by the terminal; and
displaying at least a portion of the plurality of images and the acquired image.

8. The method of claim 7, further comprising:
transmitting the acquired image to a server,
wherein a database for selecting the plurality of images is updated based on the acquired image transmitted to the server.

9. The method of claim 1,
wherein an image with positive feedback from a customer is selected as the first image of the plurality of images.

10. The method of claim 9, further comprising:
identifying sixth information on a delivery-related alert message; and
displaying the sixth information in a sixth area of the display,
wherein the alert message is generated based on customer feedback information.

11. A courier terminal, comprising:
a transceiver configured to communicate with a server storing a set of images previously acquired during completion of one or more previous deliveries corresponding to a delivery address;
a display configured to display information, wherein the display comprises a first area, a second area, and a third area; and
a controller configured to:
identify first information on the delivery address;
identify second information on a customer;
receive a plurality of images selected from the set of images stored at the server, the plurality of images being automatically selected by the server based on customer feedback information regarding the one or more previous deliveries;
identify third information on plurality of images related to a delivery;
display the first information in the first area, the second information in the second area, and the third information in the third area, wherein a first image of the plurality of images related to the delivery is displayed within the third area of the display without scrolling images on the display, the first image having a higher priority than a second image of the plurality of images based on the customer feedback information; and
displaying the second image of the plurality of images in the third area of the display subsequent to the displaying of the first image, in response to scrolling the images on the display.

12. The courier terminal of claim 11, wherein the controller is further configured to:
identify fourth information on a delivery complete type; and
display the fourth information in a fourth area of the display.

13. The courier terminal of claim 12, wherein the controller is further configured to:
receive an input of selecting one of the fourth information displayed in the fourth area; and
change a shape of an icon corresponding to the information selected in response to the input.

14. The courier terminal of claim 11,
wherein the third information comprises the priority information regarding at least a portion of the plurality of images,
wherein the plurality of images are displayed on the display based on the priority information.

15. The courier terminal of claim 14, wherein the priority information is determined based on at least one of the following:
an acquisition time of the plurality of images is acquired; and
the customer-related information corresponding to the plurality of images.

16. The courier terminal of claim 14, wherein the priority information is determined based on information on a delivery location corresponding to the plurality of images and the customer feedback information corresponding to the plurality of images.

17. The courier terminal of claim 11, wherein the controller is further configured to:
identify fifth information for attaching a photo;
display the fifth information in a fifth area of the display;
in response to an input to the fifth area, acquire an image stored in the terminal or an image photographed by the terminal; and
display at least a portion of the plurality of images and the acquired image.

18. The courier terminal of claim 17,
wherein the controller is further configured to transmit the acquired image to a server,
wherein a database for selecting the plurality of images is updated based on the acquired image transmitted to the server.

19. The courier terminal of claim 11,
wherein an image with positive feedback from the customer is selected as the first image of the plurality of images.

20. The courier terminal of claim 11, wherein the controller is further configured to:
identify sixth information on a delivery-related alert message; and
display the sixth information in the sixth area.
